(19) United States
(12) Patent Application Publication
(10) Pub. No.: US 2010/0207081 A1
(43) Pub. Date: Aug. 19, 2010

(54) Tool with working and positioning Devices

(76) Inventor: Mou-Tang LIOU, Ta Li City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/371,648

(22) Filed: Feb. 16, 2009

(51) Int. Cl. B66F 15/00

(52) U.S. Cl. 254/129; 7/166; 7/143

(57) ABSTRACT

A tool adapted for prying comprises a handle including a pivotal end and a grip end, with the pivotal end having a through-hole; a working device having first and second ends, with the first end of the working device pivotally connected to the pivotal end of the handle and including a positioned hole formed transversely and a cavity formed longitudinally and communicating with the positioned hole, with the positioned hole corresponding to the through-hole; and a positioning device disposed at the through-hole, the positioned hole and the cavity and moveable between a fixing position and an adjusting position.

### BACKGROUND OF THE INVENTION

1. Field of the Invention

The present invention relates to a tool having a working device which includes prongs for extracting an element to be pried and a positioning device adapted for positioning the prying device at various angles with respect to a handle of the tool.

2. Description of the Related Art

A tool, generally known as crowbar, includes a straight bar and a working end slightly bent with respect to the bar and forked. In operation, the working end is engaged with an element to be extracted and the straight bar is used as a lever to pivot about a fulcrum.

However, the working end is usually fixed to the straight bar and cannot be adjustably connected to the straight bar at various angles. It's not convenient to be used in various slopes. The present invention is, therefore, intended to obviate or at least alleviate the problems encountered in the prior art.

### SUMMARY OF THE INVENTION

According to the present invention, a tool includes a handle and a prying device pivotally connected to the handle and positionable at various pivoting positions with respect to the handle. The prying device is engagable with an object to be pried and the handle is utilized as a lever to extract the object efficiently. The tool also includes a hammering portion.

It is an aspect of the present invention that the toot is usable for prying an object and used as a hammer.

It is another aspect of the present invention that the tool has a simple structure and is manufactured cost-effectively.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

FIG. 1 is a perspective view of a tool in accordance with the first embodiment of the present invention.

FIG. 2 is an exploded perspective view of the tool shown in FIG. 1.

FIG. 3 is a cross-sectional view taken along line 3-3 of FIG. 1.

FIG. 4 is a cross-sectional view taken along line 4-4 of FIG. 1.

FIG. 5 is another cross-sectional view similar to FIG. 3.

FIG. 6 is another cross-sectional view similar to FIG. 4.

FIG. 7 is a side view of the tool shown in FIG. 1.

FIG. 8 is a perspective view of a tool in accordance with the second embodiment of the present invention.

FIG. 9 is an exploded perspective view of the tool shown in FIG. 8.

FIG. 10 is another perspective view of the tool shown in FIG. 8.

FIG. 11 is a perspective view of a tool in accordance with the third embodiment of the present invention.

FIG. 12 is an exploded perspective view of the tool shown in FIG. 11.

FIG. 13 is a partial, cross-sectional view of the tool shown in FIG. 11.

FIG. 14 is another partial, cross-sectional view of the tool shown in FIG. 11.

FIG. 15 is another partial, cross-sectional view of the tool similar to FIG. 13.

FIG. 16 is another perspective view of the tool shown in FIG. 11.

### DETAILED DESCRIPTION OF THE PREFERRED EMBODIMENT

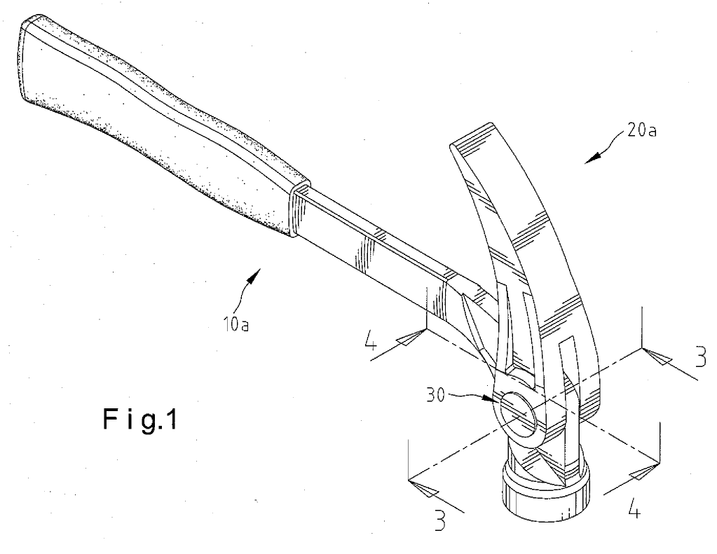

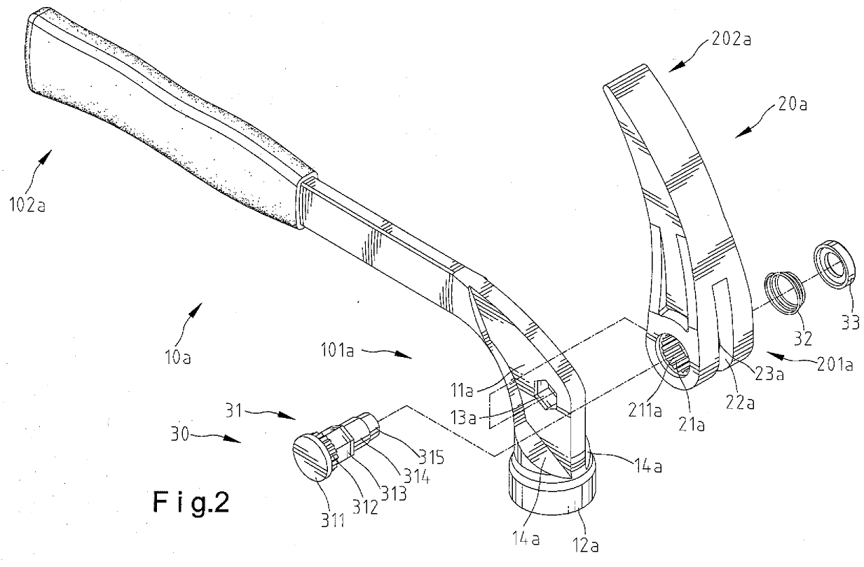

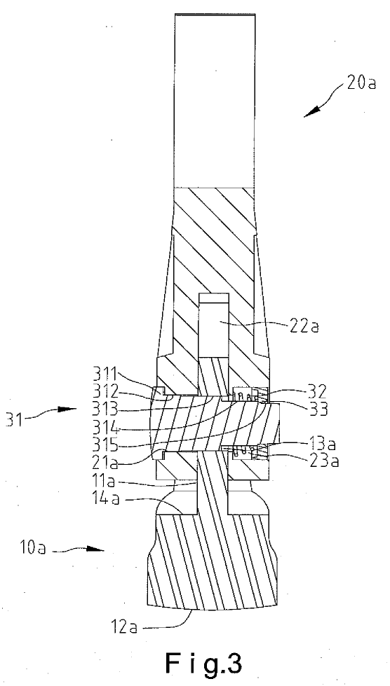

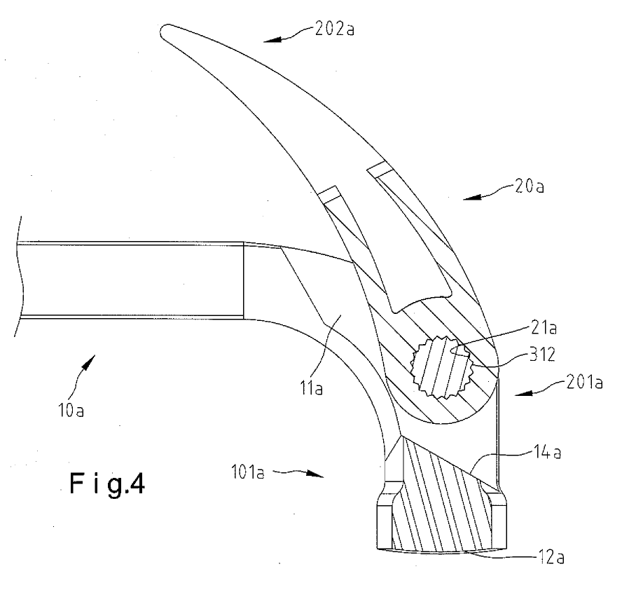

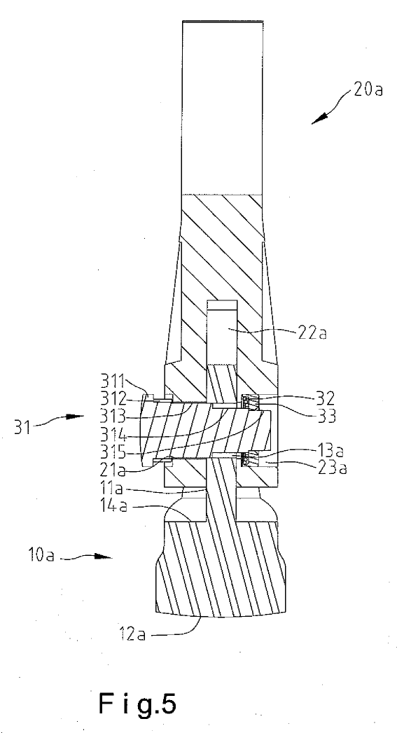

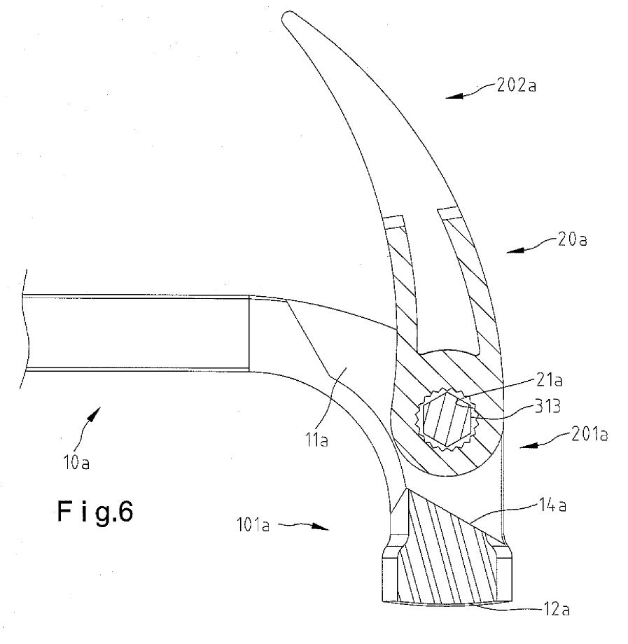

FIGS. 1 through 7 show a tool usable for prying in accordance with a first embodiment of the present invention. The tool includes a handle 10a, working device 20a and a positioning device 30 which is moveable between a fixing position and an adjusting position. And while the positioning device 30 is in the fixing position, the handle 10a is fixed in position with respect to the working device 20a. While the positioning device 30 is in the adjusting position, the handle 10a is able to pivot with respect to the working device 20a.

The handle 10a includes a pivotal end 101a and a grip end 102a. A flat coupled portion 11a is defined at the pivotal end 101a and a hammering portion 12a extends from the distal of the pivotal end 101a treated as a hammer. The coupled portion 11a includes a hexagonal through-hole 13a transversely formed thereon and two limited portions 14a formed on two sides thereof and proximal to the hammering portion 12a.

The working device 20a includes first and second ends 201a, 202a. The second end 202a is in form of pry. A positioned hole 21a, a slot 22a and a cavity 23a are formed at the first end 201a and communicate with one another in sequence. The slot 22a, which is sandwiched between the positioned hole 21a and the cavity 23a and extends from the first end 201a to the second end 202a, is mounted on the pivotal end 101a of the handle 10a. The positioned hole 21a corresponds to the through-hole 13a and has a plurality of positioning sections 211a defined on the periphery thereof as to form the positioned hole 21a to be a ratchet hole preferably. In this case, the cavity 23a is in form of circle hole. Moreover, in other embodiment, attachment of the handle 10a and the working device 20a can be achieved via the coupled portion 11 a is mounted on the first end 201a of the working device 20a.

The positioning device 30 is disposed at the through-hole 13a, the positioned hole 21a and the cavity 23a and consists of a controller 31, a resilient member 32 and a retaining member 33. The controller 31 includes a cap 311, a plurality of detents 312, first and second body sections 313, 314 and a joint 315. The controller 31 is inserted through the pivotal end 101a and adapted to connect the working device 20a to the handle 10a. The cap 311 exposes from the positioned hole 21a and the plurality of detents 312 are removably meshed with the plurality of positioning sections 211a. The first body section 313 is adjacent to the cap 311 and has a hexagonal cross-section as to correspond to and engage with the trough-hole 13a. The second body section 314 is adjacent to the joint 315 and inserted through the resilient member 32 in the cavity 23a. The joint 315 is attached to the retaining member 33 in an adhesive manner or a screw manner for preventing the controller 31 removing from the working device 20a.

While the positioning device 30 is in the fixing position, the detents 312 are engaged with the positioning sections 211a of the working device 20a so that the handle 10a is fixed with respect to the working device 20a. The profile of the first body section 313 corresponds to that of the through-hole 13a so that the controller 31 cannot rotate with respect to the handle 10a. The resilient member 32 and the retaining member 33 are limited in the cavity 23a and the positioning device 30 is restricted at the handle 10a and working device 20a via the cap 311 and the retaining member 33.

While the positioning device 30 is in the adjusting position, the handle 10a is able to rotate with respect to the working device 20a. Users push the retaining member 33 of the positioning device 30 to press the resilient member 32 and further the controller 31. And then, the detents 312 are disengaged from the positioning sections 211a of the positioned hole 21a. Therefore, users can adjust the working device 20a to a desired angle with respect to the handle 10, next, to release the retaining member 33 as to return the positioning device 30 to be in the fixing position.

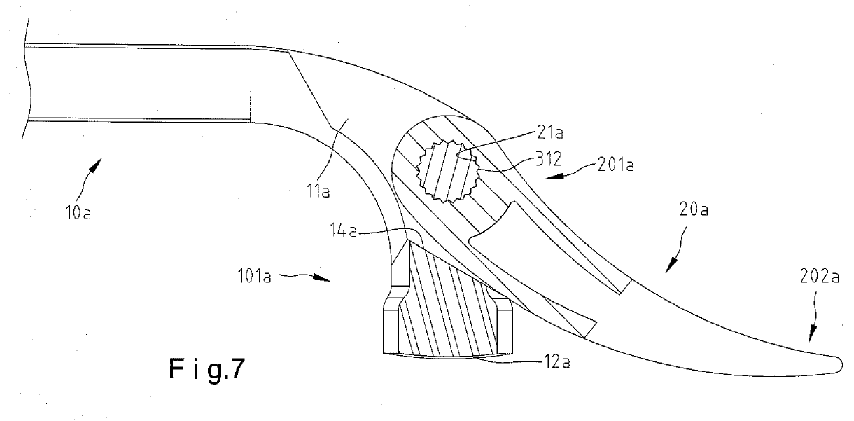

The limited portions 14a are adapted to restrict rotation of the working device 20a with respect to the handle 10a. As shown in FIG. 7, the limited portions 14a prevents the working device 20a rotating over the hammering portion 12a. Further, while the working device 20a is used to extract an element to be pried, the limited portions 14a provide a support force to the working device 20a and prevent the working device 20a detaching from the handle 10a.

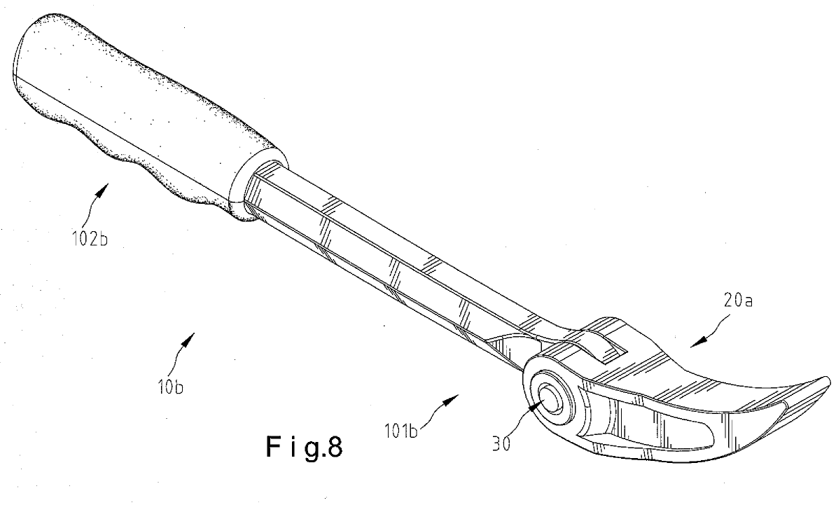

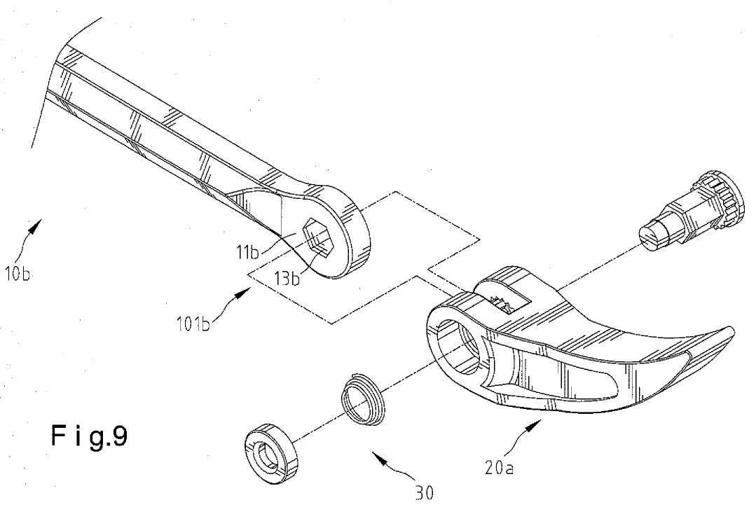

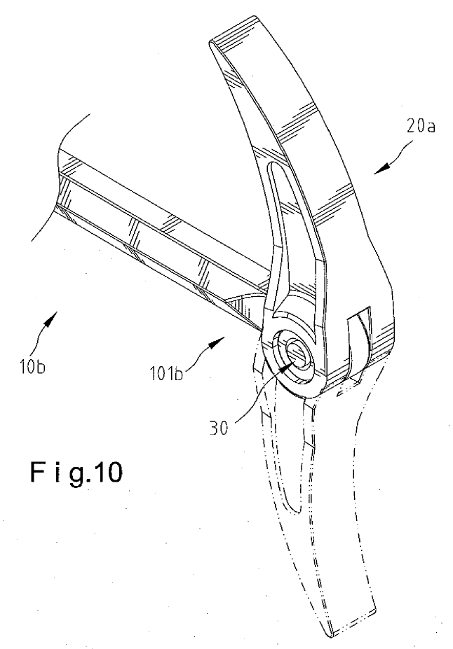

FIGS. 8 through 10 show that a tool is usable for prying in accordance with a second embodiment of the present invention and similar to the first embodiment except that a handle 10b replaces the handle 10a. The handle 10b includes a pivotal end 101b and a grip end 102b. A flat coupled portion 11b is defined at the pivotal end 101b and a hexagonal through-hole 13b is transversely formed on the coupled portion 11b and corresponds to the positioned hole 21a. And the positioning device 30 is disposed at the through-hole 13b.

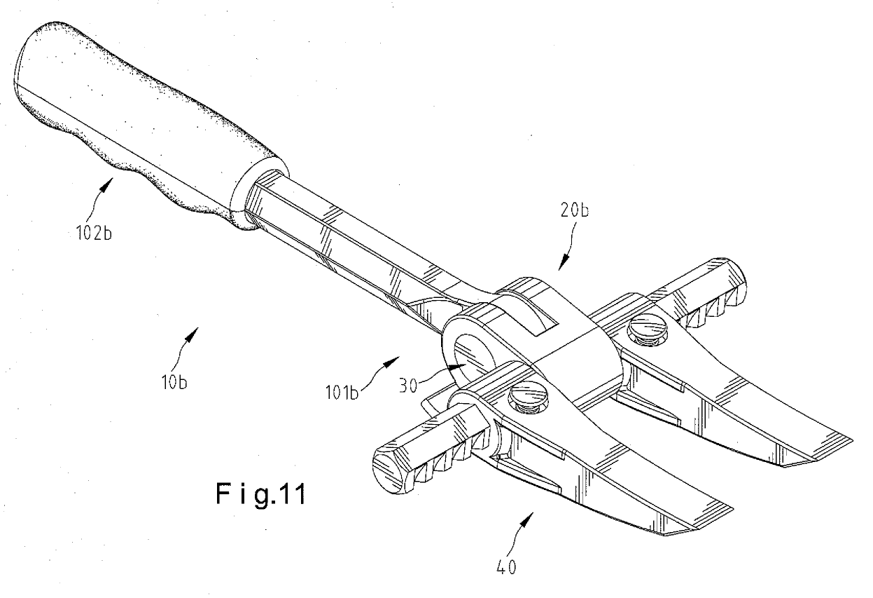

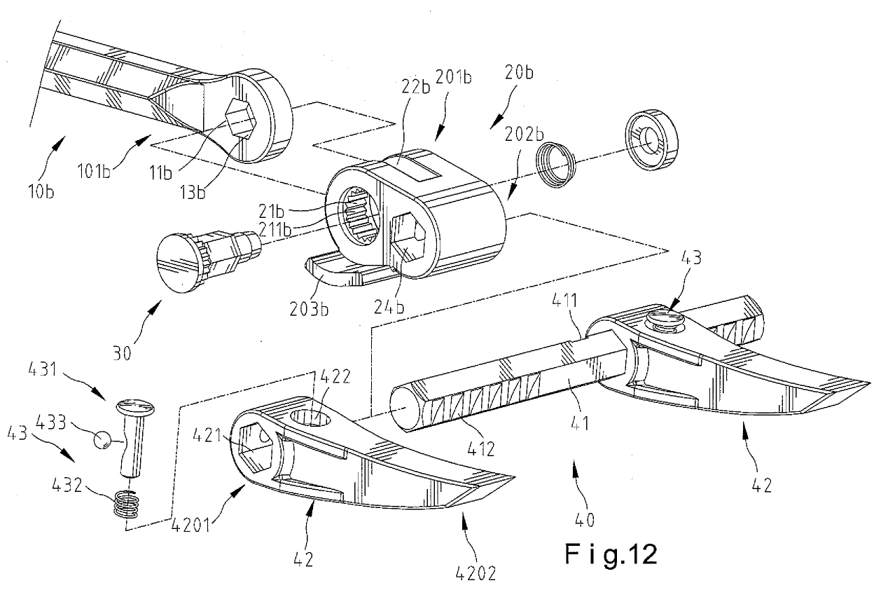

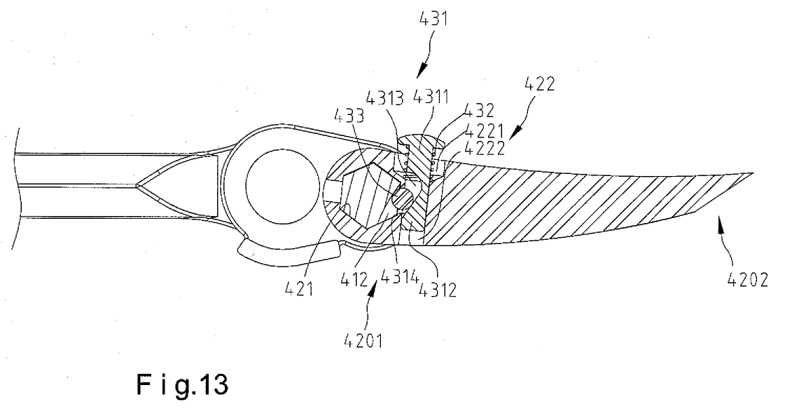

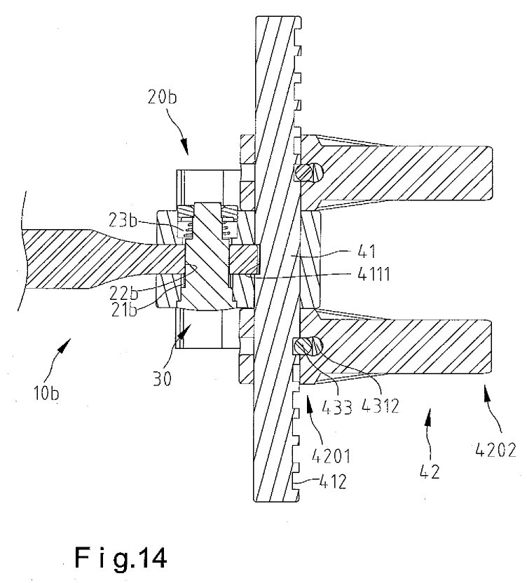

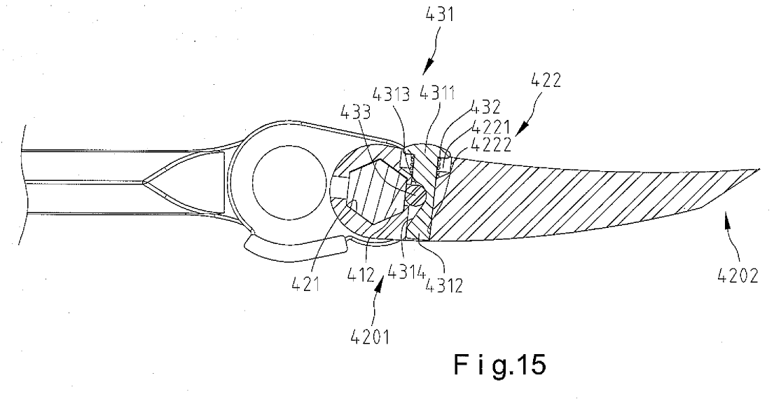

FIGS. 11 through 16 show that a tool is usable for prying in accordance with a third embodiment of the present invention and similar to the second embodiment except that a working device 20b replaces the working device 20a and a prying device 40 is further attached to the working device 20b for extracting an element to be pried. The working device 20b has first and second ends 201b, 202b and a pressed portion 203b formed on the outer periphery thereof between the first and second ends 201b, 202b. The prying device 40 is coupled to the second end 202b. A positioned hole 21b, a slot 22b and a cavity 23b are formed at the first end 201b and communicate with one another in sequence. The slot 22b, which is sandwiched between the positioned hole 21b and the cavity 23b and extends from the first end 201b to the second end 202b, is mounted on the pivotal end 101b of the handle 10b. The positioned hole 21b corresponds to the through-hole 13b and has a plurality of positioning sections 211b defined on the periphery thereof as to form the positioned hole 21b to be a ratchet hole preferably. In this case, the cavity 23b is in form of circle hole. A hexagonal coupled hole 24b is transversely formed at the second end 202b and communicates with the slot 22b. The coupled hole 24b is spaced from the positioned hole 21b.

The prying device 40 consists of a shaft 41 adapted for inserted through the coupled hole 24b, two pry elements 42 and two positioning units 43. A notch 411 is formed on the outer periphery of the center of the shaft 41. A plurality of positioning sections 412 are respectively provided on the outer periphery of two ends of the shaft 41 in transverse line arrangement.

Each pry element 42 has first and second ends 4201, 4202. First and second connected holes 421, 422 are formed on the first end 4201 and communicate with each other. The first connected hole 421 is preferably being a polygon hole and perpendicular to the second connected hole 422. The second hole 422 has first and second sections 4221, 4222, and a diameter of the first section 4221 is larger than that of the second section 4222. The second end 4202 is treated as a pry.

Each positioning unit 43 is adapted to removably fix the related pry element 42 to the related end of the shaft 41 and consists of a control member 431, a resilient member 432 and a detent 433. The control member 431 is inserted into the second connected hole 422 and has a head 4311 and a body 4312. A recess 4313 and an abutting section 4314 are formed on the body 4312. The resilient member 432 is mounted on the body 4312 and restricted at the first section 4221 of the second connected hole 422. The detent 433 is restricted between the recess 4313 and the abutting section 4314 and positioned at the second section 4222 of the second connected hole 422. The detent 433 is moveable between the selected one positioning section 412 and the recess 4313 and selectively engaged with the selected one positioning section 412 or the recess 4313 as to fix the pry elements 42 to the shaft 41 or not. While the detent 433 that is in a first position and engaged with the selected one positioning section 412 and against the abutting section 4314, it prevents the pry elements 42 from rotating with respect to the shaft 41. While the detent 433 is driven to be in a second position by pressing the head 4311 of the control member 431, the resilient member 432 is pressed via the control member 431 and the detent 433 is disengaged from the abutting section 4314 and the selected one positioning section 412, both. Then, the detent 433 is engaged with the recess 4313 so that the pry elements 42 are moveable with respect to the shaft 41.

Moreover, the distal of the pivotal end 101b is inserted into the notch 411 on the center of the shaft 41. Therefore, the handle 10b can be aligned with the center of the shaft 41.

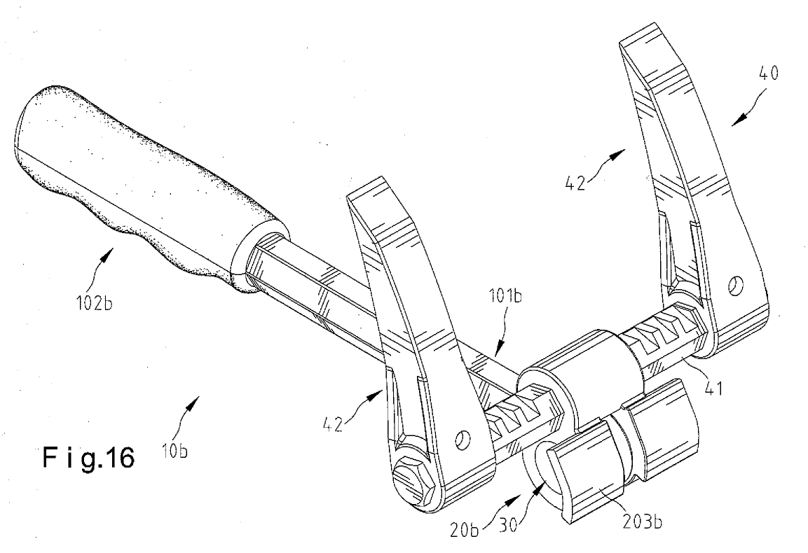

To operate the positioning device 30 (as shown in FIG. 16), the working device 20b is able to rotate with respect to the handle 10b till the pressed portion 203b is driven to be positioned opposite to the handle 10b with respect to the shaft 41 so that the pressed portion 203b can be adapted to be used for abutting with the ground or any item.

While the specific embodiments have been illustrated and described, numerous modifications come to mind without significantly departing from the spirit of invention and the scope of invention is only limited by the scope of accompanying claims.

I what is claimed is:

1. A tool adapted for prying comprising:
a handle including a pivotal end and a grip end, with the pivotal end having a through-hole;
a working device having first and second ends, with the first end of the working device pivotally connected to the pivotal end of the handle and including a positioned hole formed transversely and a cavity formed longitudinally and communicating with the positioned hole, with the positioned hole corresponding to the through-hole; and
a positioning device disposed at the through-hole, the positioned hole and the cavity and moveable between a fixing position and an adjusting position;
wherein while the positioning device is in the fixing position, the handle is fixed in position with respect to the working device; wherein while the positioning device is in the adjusting position, the handle is able to pivot with respect to the working device.

2. A tool as claimed in claim 1 wherein the positioning device further comprises a plurality of detents and a first body section corresponding to and engaging with the trough-hole of the handle; wherein the positioned hole includes a plurality of positioning sections defined on the periphery thereof, with the plurality of detents removably meshed with the plurality of positioning sections.

3. A tool as claimed in claim 2 wherein the positioning device consists of a controller, a resilient member and a retaining member, with the plurality of detents and the first body section located at the controller, with the resilient and retaining members disposed in the cavity, with the controller inserted through the resilient member and coupled to the retaining member.

4. A tool as claimed in claim 1 further comprising a coupled portion defined at the pivotal end and inserted into a slot defined at the working device, with the slot sandwiched between the positioned hole and the cavity and extends from the first end to the second end of the working device.

5. A tool as claimed in claim 4 further comprising a hammering portion extends from the distal of the pivotal end treated as a hammer.

6. A tool as claimed in claim 5 further comprising two limited portions formed on two sides of the coupled portion and proximal to the hammering portion.

7. A tool as claimed in claim 1 further comprising a prying device attached to the second end of the working device for extracting an element to be pried.

8. A tool as claimed in claim 7 further comprising a pressed portion formed on the outer periphery of the working device between the first and second ends.

9. A tool as claimed in claim 7 wherein the prying device comprises a shaft, two pry elements moveably disposed at two ends of the shaft and two positioning units, with each positioning unit adapted to removably fix the related pry element to the related end of the shaft.

10. A tool as claimed in claim 9 further comprising a plurality of positioning sections are respectively provided on the outer periphery of two ends of the shaft in transverse line arrangement and first and second connected holes formed on each pry element and communicating with each other, with the shaft inserted into the first connected hole, with the positioning units disposed in the second connected holes and selectively engaged with the selected one positioning section.

11. A tool as claimed in claim 10 wherein each positioning units consists of a control member, a resilient member and a detent, with the control member inserted into the second connected hole, with the detent moveable between the selected one positioning section and a recess formed on the control member and selectively engaged with the selected one positioning section or the recess.

12. A tool as claimed in claim 11 wherein the control member has a head and a body, with the recess and an abutting section formed on the body; wherein the detent is restricted between the recess and the abutting section and positioned at the second connected hole.

13. A tool as claimed in claim 12 wherein the second hole of each pry element has first and second sections, and a diameter of the first section is larger than that of the second section.

14. A tool as claimed in claim 13 wherein the resilient member is mounted on the body and restricted at the first section of the second connected hole.

15. A tool as claimed in claim 3, with the through-hole being hexagonal, and with the first body section having a hexagonal cross-section as to correspond to and engage with the trough-hole.

16. A tool as claimed in claim 3 wherein the controller 31 further includes a cap, a second body section and a joint, with the cap exposing from the positioned hole and opposite to the joint, with the first body section adjacent to the cap, with the second body section adjacent to the joint and inserted through the resilient member in the cavity, and with the joint attached to the retaining member.

17. A tool as claimed in claim 9 further comprising a coupled hole transversely formed at the second end and communicates with the slot; wherein the coupled hole is spaced from the positioned hole and inserted by the shaft of the prying device.
